(19) United States
(12) Patent Application Publication
(10) Pub. No.: US 2024/0336038 A1
(43) Pub. Date: Oct. 10, 2024

(54) GLAZED UNIT HAVING TRANSPARENT POLYCHROMIC COLOURING, AND METHOD FOR PRODUCING SAME BY LIQUID DEPOSITION IN ONE OR MORE PASSES

(71) Applicant: SAINT-GOBAIN GLASS FRANCE, COURBEVOIE (FR)

(72) Inventors: Kamel CHAHBOUNE, COURBEVOIE (FR); Leila DUMOTIER, COURBEVOIE (FR)

(21) Appl. No.: 18/700,007

(22) PCT Filed: Oct. 18, 2022
(86) PCT No.: PCT/FR2022/051968

§ 371 Date: Apr. 10, 2024

(30) Foreign Application Priority Data
Oct. 26, 2021 (FR) FR2111352

(51) Int. Cl. B32B 17/10; B32B 37/24

(52) U.S. Cl. CPC B32B 17/10055; B32B 17/10146; B32B 37/24; B32B 2037/243; B32B 2255/20; B32B 2307/4026; B32B 2307/412; B32B 2307/416; B32B 2307/7376

(57) ABSTRACT

A method for producing a glazed unit having a glass substrate which bears a mineral coating which forms a discontinuous surface made up of discrete patterns, the substrate provided with the coating remaining transparent, wherein the thickness of the mineral coating is not constant, with each thickness value of the coating producing a characteristic color in reflection, said discrete patterns having locally controlled variable heights. The method includes the deposition, in discrete patterns, of a thickness of between 5 and 60 μm of a liquid precursor of the mineral coating by an etched roller having locally calibrated cavities of different depths, followed by a heat treatment at a temperature of between 30° and 800° C. for 30 s to 1 h.

The invention relates to obtaining, on a transparent glass substrate, a polychromic heterogeneous transparent decoration. Transparent thin layers (sol-gel, ink) have different colorings in reflection according to the thickness of the layers and the angle of observation, in accordance with Newton's law of colors. The invention therefore aims to provide transparent glazed units for cars, buildings, urban furniture, interior decoration and electrical domestic appliances having new aesthetic aspects. It was sought to obtain several colorings in reflection by implementing processes that can easily be industrialized.

The inventors have succeeded in the preparation of glazed units meeting these expectations. Consequently, the invention relates to a method for producing a glazed unit having a glass substrate which bears a mineral coating which forms a discontinuous surface made up of discrete patterns, the substrate provided with the coating remaining transparent, wherein the thickness of the mineral coating is not constant, with each thickness value of the coating producing a characteristic color in reflection, said discrete patterns have locally controlled variable heights, characterized in that it comprises the deposition, in discrete patterns, of a thickness of between 5 and 60 μm of a liquid precursor of the mineral coating, in particular of a sol, by means of an etched roller having locally calibrated cavities of different depths, followed by a heat treatment at a temperature of between 30° and 800° C. for 30 s to 1 h, in particular a heat strengthening treatment of the glass substrate.

The term “glass substrate” here refers to a transparent sheet made of polymer material of the poly(methyl methacrylate) (PMMA), polycarbonate (PC) type or preferably made of mineral glass such as soda-lime-silica, aluminosilicate, borosilicate, optionally hardened, thermally tempered or chemically toughened.

It was thus possible to obtain two particular forms of coating surfaces under conditions which are easily industrializable. According to the first form, excluded from the present invention, the continuous or flat surface has a variation without discontinuity of the thickness able to produce, in reflection, a continuous variation of the coloring, that is, a gentle transition between different colors, a color gradient effect, without discontinuity, “seamless.” Within the meaning of the invention, the term “an area of variation without discontinuity of the thickness of the coating” is understood to mean an area of the coating of variable thickness, wherein this thickness is a continuous function in all directions of its surface. In other words, this surface does not have any discontinuity of coating thickness and height like, by analogy, a surface area of terrain free from any cliffs, cracks and sudden, periodic variations in height, level or altitude. According to the second form, according to the present invention, the discontinuous surface made up of discrete patterns is also able to produce this color gradient effect with a gentle transition: to obtain this effect, the layer or envelope of the discontinuous coating, obtained by connecting the apex of all the discrete features, in particular has a geometry that is as close as possible to said first form described above, that is, with as few irregularities in the pattern heights as possible; ideally no small group consisting of a few neighboring discrete features, and even no isolated discrete pattern, form an acute apex of said layer or envelope. This second discontinuous form of the coating surface thus makes it possible to form colored patterns with gentle transitions between different colors in reflection, forming discrete patterns of increasing (decreasing) heights in a regular manner over the entire surface, or on the contrary with sharp transitions, sharp edges, a greater contrast, for example forming discrete patterns in adjacent areas of different colors, each color corresponding to a unique height of the patterns, and two adjacent areas not being separated by any transition area with patterns of intermediate heights between the heights corresponding to the two colorations. In general, the geometry, the height, all the dimensions, the distribution and the density of the discrete patterns are controlled, to constitute decorative colored patterns of homogeneous color by areas of several neighboring patterns: many decorative, optical effects are thus made accessible.

As will be seen in more detail below, the characteristic mineral coating of the invention is easily obtained industrially.

Another object of the invention consists of a glazed unit obtained by the method mentioned above, characterized in that said glass substrate is bonded to another glass substrate by means of an adhesive interlayer to constitute a laminated glazed unit, one of the outer surfaces of which consists of said mineral coating, in particular the surface intended to be in contact with the outside atmosphere, in the mounting position. The main examples of adhesive interlayer are polyvinyl butyral (PVB), thermoplastic polyurethane (TPU), ethylene-vinyl acetate copolymer (EVA), ionomer resin, and any transparent casting resin.

Another object of the invention, which can be combined with the preceding one, consists of a glazed unit obtained by the method mentioned above, characterized in that said glass substrate, optionally laminated, is associated with another glass substrate, optionally laminated, by means of a mounting joint holding the glass substrates with a gap defining an air or gas gap, so as to constitute a multiple glazed unit, one of the outer surfaces of which consists of said mineral coating, in particular the surface intended to be in contact with the outside atmosphere, in the mounting position.

Another object of the invention consists of a glazed unit obtained by the method mentioned above, characterized in that the variable thickness of the mineral coating is between 20 nm and 1 μm, in particular between 50 and 800 nm.

In an industrially advantageous embodiment of the invention, the mineral coating is based on oxide, in particular a sol-gel coating, that is, a coating obtained by a sol-gel process, the oxide being in particular chosen from titanium oxides, silicon oxides, zirconium oxides, tin oxides, zinc oxides, aluminum oxides, indium oxides and transition metal oxides. The transition metals are in particular copper, iron, cobalt, chromium and manganese.

The transparent mineral coating may have a colored appearance due to the presence of pigments or metal particles, for example.

A sol-gel process typically comprises:
forming a “sol”, i.e. a solution containing at least one precursor of the oxide to be deposited,
applying this solution to the surface to be coated,
consolidating or densifying the coating by means of a heat treatment.

The precursor particularly comprises salts of the element whose oxide is to be deposited. They are particularly organometallic compounds or else nitrates, acetates, chlorides, etc. As examples of organometallic compounds, mention may for example be made of alkoxides, for example tetraorthosilicate (TEOS) in the case of a layer of silicon oxide, or titanium tetraisopropoxide in the case of a layer of titanium oxide.

The sol may be partially aqueous. It preferably comprises an organic solvent, for example an alcohol, particularly selected from ethanol, isopropanol, butanol and glycols or glycol derivatives, and mixtures thereof. The sol may further contain viscosity regulators, such as cellulose ethers or polyacrylates.

In a particular and interesting non-exclusive embodiment of the invention, the glazed unit comprises one said mineral coating on at least two faces of one and/or several glass substrate(s); a superposition of mineral coatings of the invention carried by at least two distinct surfaces of one or more glass substrate(s) is in particular capable of producing new colorings in reflection, and a visual effect of depth/relief.

In another interesting embodiment, the glass substrate is made of colored glass, modifying the Newton's shades of the mineral coating in reflection.

In another interesting embodiment, the glazed unit comprises a layered glass substrate. Reference is made here to a functional stack of thin layers, in particular of the type obtained by magnetron sputtering, such as thermal control (solar-control, low-E) or the like. This stack is also of a nature to modify the coloration in reflection of the mineral coating with a non-constant thickness, by its superposition with the latter.

In another non-exclusive interesting embodiment, the glass substrate is made of satin or acid glass or textured glass, so as to add a visual effect of relief to the colored reflection of the mineral coating.

The invention also relates to the application of a glazed unit described above as a quarter window, rear window, roof or other glazed unit for a motor vehicle, facade, partition, shower wall, balcony or other glazed unit for a building, bus shelter or other glazed unit for urban furniture, glazed unit for interior decoration, oven door or other glazed unit for electrical domestic appliances.

The invention is now illustrated by the following exemplary embodiments.

### EXAMPLES

Variable thicknesses of liquid solutions sold by Ferro under the reference GSGF SILVER Lustreflex TLU0050A-MD were deposited on 3.85 mm thick sheets of soda-lime-silica glass with a green hue (light transmission factor LT of 40%) on the one hand, body tinted glass sold by Saint-Gobain Glass under reference VG10 (Venus Grey with a LT of 10%) on the other hand.

In these examples, all the proportions are indicated in percentages by weight. The liquid solutions TLU0050 are precursors of reflective ceramic coatings based on titanium oxide, intended to be subjected to a heat treatment on their glass substrate. The titanium oxide precursor is titanium tetraisopropanolate (3 to 10%), mixed with organic compounds: hexa-2,4-dienoic acid (3 to 5%), rosin (2.5 to 10%), heavy (oil) aromatic naphtha solvent (1 to 10%), N-(2-ethylhexyl)-1-[3-methyl-4-[(3-methylphenyl)azo]phenyl]azo]naphthalene-2-amine (0.1 to 1%) in an organic solvent (ether/glycol acetate, acid/ester/carbonic acid, vegetable oil/terpene/balm/resin, acid/organic base salt, carbohydrate/cellulose (derivative)).

The deposition of TLU0050 by means of an etched roller having locally calibrated cavities of different depths mainly produces a liquid layer, then a coating of dry titanium oxide after heat treatment, in the second discontinuous form made up of discrete patterns. The etched roller makes it possible to deposit drops, points, lines or other geometric patterns in a single pass according to different local thicknesses. The cavities of the roller may be in the form of pyramids with a square or honeycomb base. The cavity width is between 150 and 1500 μm, in particular of the order of 500 μm; the cavity height is between 50 and 500 μm, in particular of the order of 150 μm. The cavities are present on all or part of the surface of the roller, according to the area wherein the formation of patterns of the mineral coating is desired. With roller cavities having a depth of 150 μm, for reference and according to the geometry of the cavity (shape of its cross section in the plane of the glass substrate), a deposited liquid thickness of TLU0050 of approximately 25 μm is produced. For printing using the etched roller, the Brookfield viscosity at 20° C. of the liquid precursor of the mineral coating is preferably between 10 mPa·s and 5 Pa·s.

After the deposition of the liquid precursor of titanium oxide, a heat strengthening treatment of the glass substrate will be suitable for firing and hardening the titanium oxide coating, which is therefore temperable. This tempering treatment is carried out at 650° C. for 45 s per glass thickness (approximately 180 s for 3.85 mm thick). If a coating is deposited on both faces of a glass substrate, pre-firing at 600° C. of the coating deposited first is necessary to make the sol-gel conveyable, and to print and fire the other face.

Thicknesses of 10-12, respectively 21-23, respectively 32-34, respectively 43-45 μm of liquid precursor harden in thicknesses of 50-70, respectively 110-130, respectively 170-190, respectively 230-250 nm of dry titanium oxide, reflecting in silvery, respectively gold-red, respectively pink-red, respectively bluish shades. These reflection shades are stronger and more contrasted on the body tinted glass with a LT of 10% than on the green-tinted glass with a LT of 40%.

1. A method for producing a glazed unit having a glass substrate which bears a mineral coating which forms a discontinuous surface made up of discrete patterns, the substrate provided with the coating remaining transparent, wherein a thickness of the mineral coating is not constant, with each thickness value of the coating producing a characteristic color in reflection, said discrete patterns have locally controlled variable heights, the method comprising depositing, in discrete patterns, a thickness of between 5 and 60 μm of a liquid precursor of the mineral coating by means of an etched roller having locally calibrated cavities of different depths, followed by performing a heat treatment at a temperature of between 30° and 800° C. for 30 s to 1 h.

2. The glazed unit obtained by a method according to claim 1, wherein said glass substrate is bonded to another glass substrate by an adhesive interlayer to constitute a laminated glazed unit one of outer surfaces of which consists of said mineral coating.

3. The glazed unit obtained by a method according to claim 1, wherein said glass substrate, optionally laminated, is associated with another glass substrate, optionally laminated, by a mounting joint holding the glass substrates with a gap defining an air or gas gap, so as to constitute a multiple glazed unit, one of outer surfaces of which consists of said mineral coating.

4. The glazed unit obtained by a method according to claim 1, wherein the variable thickness of the mineral coating is between 20 nm and 1 μm.

5. The glazed unit according to claim 4, wherein the mineral coating is oxide-based.

6. The glazed unit according to claim 5, wherein the mineral coating is a sol-gel coating.

7. The glazed unit according to claim 6, wherein the oxide is selected from the group formed by titanium oxides, silicon oxides, zirconium oxides, tin oxides, zinc oxides, aluminum oxides, indium oxides and transition metal oxides.

8. The glazed unit according to claim 4, comprising one said mineral coating on at least two faces of one and/or several glass substrate(s).

9. The glazed unit according to claim 4, wherein the glass substrate is made of colored glass.

10. The glazed unit according to claim 4, comprising a layered glass substrate.

11. The glazed unit according to claim 4, wherein the glass substrate is made of satin or acid glass or textured glass.

12. A method comprising providing a glazed unit obtained by a method according to claim 1 as a quarter window, rear window, roof or other glazed unit for a motor vehicle, facade, partition, shower wall, balcony or other glazed unit for a building, bus shelter or other glazed unit for urban furniture, glazed unit for interior decoration, oven door or other glazed unit for electrical domestic appliances.

13. The glazed unit obtained by a method according to claim 1, wherein the heat treatment is a heat strengthening treatment of the glass substrate.

14. The glazed unit obtained by a method according to claim 2, wherein said one of the outer surfaces is a surface intended to be in contact with the outside atmosphere in a mounting position.

15. The glazed unit obtained by a method according to claim 3, wherein said one of the outer surfaces is a surface intended to be in contact with the outside atmosphere in the mounting position.

16. The glazed unit obtained by a method according to claim 4, wherein the variable thickness of the mineral coating is between 50 and 800 nm.
